(19) United States
(12) Patent Application Publication
(10) Pub. No.: US 2014/0080711 A1
(43) Pub. Date: Mar. 20, 2014

(54) SUSPENSION OF PARTICLES COMPRISING CYCLOPROPENE COMPLEXES DISPERSED IN A RESIN MATRIX

(71) Applicant: AgroFresh Inc., Spring House, PA (US)

(72) Inventors: Shiling Zhang, Shanghai (CN); Christian Guy Becker, King of Prussia, PA (US); Yunfei Yan, Shanghai (CN); Yutian Shi, Shanghai (CN); Yongchun Chen, Shanghai (CN); Thomas H. Kalantar, Midland, MI (US); Yueqian Zhen, Paoli, PA (US); Xiuhan Grace Yang, Shanghai (CN); Christopher John Tucker, Midland, MI (US)

(21) Appl. No.: 14/029,460

(22) Filed: Sep. 17, 2013

Related U.S. Application Data
(63) Continuation-in-part of application No. PCT/CN2012/081468, filed on Sep. 17, 2012.
Application No. PCT/CN2012/081468 is a continuation-in-part of application No. PCT/CN2013/071358, filed on Feb. 5, 2013.
(60) Provisional application No. 61/713,924, filed on Oct. 15, 2012.
(60) Provisional application No. 61/791,932, filed on Mar. 15, 2013.

(51) Int. Cl. A01N 25/22; A01N 27/00

(52) U.S. Cl. CPC A01N 25/22; A01N 27/00
USPC 504/357

(57) ABSTRACT

Compositions for delivering an active ingredient include particles comprising an active ingredient (for example, 1-MCP complex powder) imbedded in a resin matrix, the particles being suspended in an oil medium. Methods for preparing such compositions include blending an active ingredient with a resin at a temperature higher than the melting point of the resin to provide a blend; dispersing the blend into an oil medium at a temperature higher than the melting point of the resin to provide a dispersion comprising dispersed particles in the oil medium; and consolidating the dispersed particles to provide consolidated particles comprising a solid matrix of the resin impregnated with the active ingredient. Methods of using such compositions include mixing the compositions with an aqueous medium to provide an emulsion or slurry and either contacting plants or plant parts with the emulsion or placing the emulsion near plants or plant parts.

### BACKGROUND

Ethylene is an important regulator for the growth, development, senescence, and environmental stress of plants, mainly affecting related processes of plant ripening, flower senescence and leaf abscission. Ethylene is usually generated in large amounts during growth of plants under environmental stress or during preservation and delivery of plants. Therefore yield of plants such as fruit and crop can be reduced under heat or drought stress before harvesting. The commercial value of fresh plants such as vegetables, fruits and flowers after harvesting is reduced by excessive ethylene gas which hastens the ripening of fruits, the senescence of flowers and the early abscission of leaves.

To prevent the adverse effects of ethylene, 1-methylcyclopropene (1-MCP) is used to occupy ethylene receptors and therefore inhibiting ethylene from binding and eliciting action. The affinity of 1-MCP for the receptor is approximately 10 times greater than that of ethylene for the receptor. 1-MCP also influences biosynthesis in some species through feedback inhibition. Thus, 1-MCP is widely used for fresh retention post-harvest and plant protection pre-harvest.

But 1-MCP is difficult to handle because it is gas with high chemical activity. To address this problem, 1-MCP gas has been encapsulated successfully by oil-in-water emulsion with 1-MCP gas dissolved in internal oil phase, but 1-MCP concentration in final product is still low (<50 ppm).

In another manner of addressing this problem, which is used in current agricultural applications, 1-MCP is complexed with cyclodextrin to form a powder. 1-MCP can be released from the complex as a gas when the powder is dissolved in water. A powder product is much more convenient to use than a product in gas form, but the powder still has disadvantages including: (1) it is not user-friendly when handling powder in the field or in an enclosed space; (2) the powder form cannot stably and uniformly be suspended in water, which leads to non-uniform delivery of 1-MCP to plants and uneven ripening response of plants; and (3) after contact with water, 1-MCP is released completely within a short period of time, which is much earlier than desired in many applications, causing some or all of the 1-MCP to be lost to the surroundings. For example, 1-MCP powder products are not properly formulated for use in water that is suitable for delaying plant maturation in the field.

One effort to solve the above problems includes mixing 1-MCP complex powder with other powders to form solid material mixtures, then processing the mixture into the form of effervescent tablets or enclosing the mixture in a water impermeable container. But such modified compositions still have disadvantages including: (1) similar to the limitations of powders, they are still limited in applications since they usually require air circulation to ensure uniform distribution of 1-MCP, which is not available in field application; and (2) they cannot be applied in the field by spraying.

Thus, there remains a need for further development of compositions for delivery of compounds including cyclopropenes or other plant growth regulators without the above and other disadvantages. The present disclosure addresses this need.

### SUMMARY OF INVENTION

The present invention relates to compositions, methods and materials for delivering a cyclopropene or other active ingredient to a plant. More particularly, the present disclosure concerns compositions that include particles comprising an active ingredient (for example, 1-MCP complex powder) imbedded in a resin matrix, the particles being suspended in an oil medium. Also provided are methods for preparing such compositions and methods for using such compositions.

In one aspect, provided is a composition comprising particles suspended in an oil medium, wherein each of the particles comprises a complex embedded in a resin matrix, and the complex comprises a cyclopropene and a molecular encapsulating agent. In various embodiments, the composition has any of the more particular features described herein below. In one embodiment, the cyclopropene is of the formula:

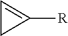

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In another embodiment, R is C₁₋₈ alkyl. In another embodiment, R is methyl.

In another embodiment, the cyclopropene is of the formula:

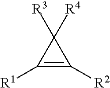

wherein R¹ is a substituted or unsubstituted C₁-C₄ alkyl, C₁-C₄ alkenyl, C₁-C₄ alkynyl, C₁-C₄ cylcoalkyl, cylcoalkylalkyl, phenyl, or napthyl group; and R², R³, and R⁴ are hydrogen. In another embodiment, the cyclopropene comprises 1-methylcyclopropene (1-MCP).

In one embodiment, the molecular encapsulating agent of any of the above-described embodiments comprises alpha-cyclodextrin, beta-cyclodextrin, gamma-cyclodextrin, or combinations thereof. In another embodiment, the ratio of the particles to the oil in any of the above-described embodiments is from about 1:5 to about 1:25. In another embodiment, the ratio of the particles to the oil is from about 1:10 to about 1:24. In another embodiment, the ratio of the resin to the oil in any of the above-described embodiments is from about 2:1 to about 1:100, by weight. In another embodiment, the ratio of the resin to the oil is from about 1:1 to about 1:100, by weight. In another embodiment, the resin matrix of any of the above-described embodiments comprises a polyester resin. In another embodiment, the resin matrix comprises a resin selected from the group consisting of a polyester, a polyether, an epoxy resin, an isocyanate, an organic amine, an ethylene vinyl acetate copolymer, a natural or synthesized wax, and combinations thereof. In another embodiment, the resin matrix comprises a polycaprolactone polyol. In another embodiment, the resin matrix comprises a polycaprolactone polyol having a molecular weight from about 2,000 to about 4,000. In another embodiment, the resin matrix comprises a polycaprolactone polyol having a melting point from about 50° C. to about 60° C.

In another embodiment, the average particle size of the suspended particles in any of the above-described embodiments is from about 1 micron to about 100 microns. In another embodiment, the average particle size is from about 10 microns to about 30 microns.

In another embodiment, the composition of any of the above-described embodiments further comprises at least one surfactant. In another embodiment, the ratio of the surfactant to the oil is from about 2:1 to about 1:20, by weight. In another embodiment, the ratio of the surfactant to the oil is from about 1:1 to about 1:10, by weight. In another embodiment, the at least one surfactant comprises a member selected from the group consisting of an anionic surfactant, a nonionic surfactant, and combinations thereof. In a further embodiment, the at least one surfactant comprises an ionic surfactant selected from the group consisting of sulfate salt, sulfonate salt, and combinations thereof. In another embodiment, the at least one surfactant comprises a nonionic surfactant selected from the group consisting of an ethoxylate of fatty alcohol, an ethoxylate of fatty acids, a block copolymer of polyoxyethylene and polyolefin, and combinations thereof.

In another embodiment, the ratio of the active ingredient to the resin matrix in any of the above-described embodiments is from about 1:1 to about 1:100, by weight. In another embodiment, the ratio of the active ingredient to the resin matrix is from about 1:2 to about 1:100, by weight.

In another aspect, provided is a method for preparing a composition. The method comprises (a) blending an active ingredient with a resin at a temperature higher than the melting point of the resin to provide a blend; (b) dispersing the blend into an oil medium at a temperature higher than the melting point of the resin to provide a dispersion comprising dispersed particles in the oil medium; and (c) consolidating the dispersed particles to provide consolidated particles comprising a solid resin matrix in which the active ingredient is embedded. In one embodiment, the method further comprises, before said dispersing, mixing a surfactant into the oil at a temperature higher than the melting point of the surfactant to provide a mixture. In another embodiment, the ratio of the surfactant to the oil is from about 2:1 to about 1:20, by weight. In another embodiment, the ratio of the surfactant to the oil is from about 1:1 to about 1:10, by weight.

In another embodiment, the mixing of any of the above-described embodiments includes applying shear forces to said mixture. In another embodiment, the blending of any of the above-described embodiments includes applying shear forces to said blend. In another embodiment, the dispersing of any of the above-described embodiments includes applying shear forces to said dispersion. In another embodiment, the consolidating of any of the above-described embodiments comprises cooling the dispersion to a temperature below the melting point of the resin. In another embodiment, the consolidating does not comprise curing.

In another embodiment, the oil medium of any of the above-described embodiments comprises a mixture of alkanes of C15 to C40, or a distillate of petroleum. In another embodiment, the oil medium comprises a member selected from the group consisting of a mineral oil, an edible oil, and combinations thereof.

In another embodiment, the temperature lower than the melting point of the resin in any of the above-described embodiments is ambient temperature. In another embodiment, the ratio of the resin to the oil in any of the above-described embodiments is from about 2:1 to about 1:100, by weight. In another embodiment, the ratio of the resin to the oil is from about 1:1 to about 1:100, by weight.

In another embodiment, the active ingredient of any of the above-described embodiments comprises a plant growth regulator. In another embodiment, the active ingredient comprises a volatile compound. In another embodiment, the volatile compound comprises a cyclopropene. In another embodiment, the cyclopropene is of the formula:

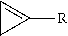

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In one embodiment, R is C₁₋₈ alkyl. In another embodiment, R is methyl.

In another embodiment, the cyclopropene is of the formula:

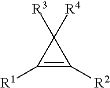

wherein R¹ is a substituted or unsubstituted C₁-C₄ alkyl, C₁-C₄ alkenyl, C₁-C₄ alkynyl, C₁-C₄ cylcoalkyl, cylcoalkylalkyl, phenyl, or napthyl group; and R², R³, and R⁴ are hydrogen. In another embodiment, the cyclopropene comprises 1-methylcyclopropene (1-MCP).

In another embodiment, the active ingredient of any of the above-described embodiments comprises a complex comprising a cyclopropene and a molecular encapsulating agent. In another embodiment, the molecular encapsulating agent of any of the above-described embodiments comprises alpha-cyclodextrin, beta-cyclodextrin, gamma-cyclodextrin, or combinations thereof. In another embodiment, the molecular encapsulating agent comprises alpha-cyclodextrin.

In another embodiment, the resin of any of the above-described embodiments comprises a polyester resin. In another embodiment, the resin comprises a resin selected from the group consisting of a polyester, a polyether, an epoxy resin, an isocyanate, an organic amine, an ethylene vinyl acetate copolymer, a natural or synthesized wax, and combinations thereof. In another embodiment, the resin comprises a polycaprolactone polyol. In another embodiment, the resin comprises a polycaprolactone polyol having a molecular weight from about 2,000 to about 4,000. In a further embodiment, the resin comprises a polycaprolactone polyol having a melting point from about 50° C. to about 60° C.

In another aspect, provided is an emulsion comprising an aqueous medium; and any of the composition embodiments described herein. In another aspect, provided is a sprayable slow-release formulation comprising the emulsion disclosed herein.

In another aspect, provided is a method of treating plants or plant parts. The method comprises contacting said plants or plant parts with an emulsion as described herein.

### BRIEF DESCRIPTION OF THE DRAWINGS

FIG. 1 shows representative coated particles of the composition provided herein, showing HAIP particles embedded in a resin matrix and surrounded by surfactants. HAIP refers to 1-methylcyclopropene/alpha-cyclodextrin complex.

FIG. 2 shows a representative release profile of 1-methylcyclopropene (1-MCP) from a mixture of HAIP in water at ambient temperature, as described in Example 5.

FIG. 3 shows a representative release profile of 1-methylcyclopropene (1-MCP) from emulsified HAIP and oil in water at different temperature for thirty (30) minutes, as described in Example 5.

FIG. 4 shows a representative release profile of 1-methylcyclopropene (1-MCP) from emulsified Sample #1 and water, as described in Example 6.

FIG. 5 shows a representative release profile of 1-methylcyclopropene (1-MCP) from emulsified Sample #2 and water, as described in Example 6.

FIG. 6 shows a typical optical image of the particles in the dispersion of Sample #2.

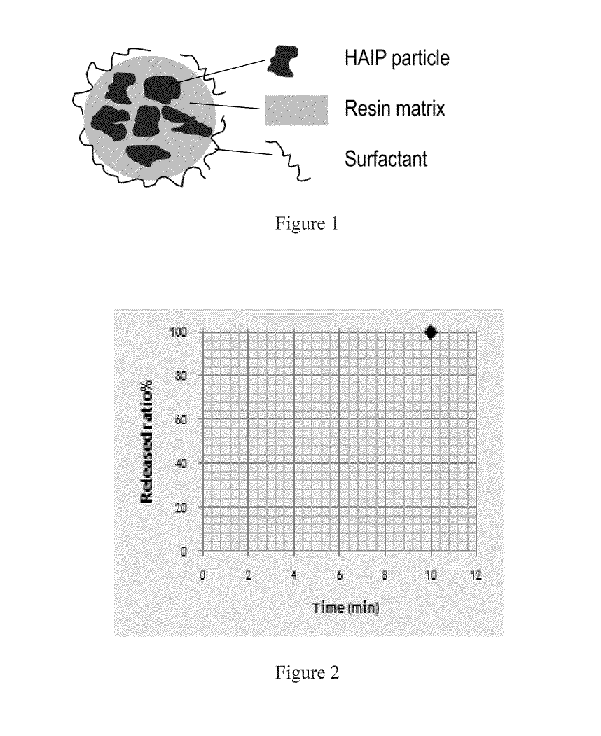

### DETAILED DESCRIPTION OF THE INVENTION

In one aspect, the present disclosure provides compositions comprising particles suspended in an oil medium, wherein each of the particles comprises an active ingredient embedded in a resin matrix. The active ingredient can be a water soluble and/or water activated active ingredient. In one embodiment, the active ingredient comprises a complex including a cyclopropene and a molecular encapsulating agent. In one embodiment, the composition further comprises a surfactant.

In one embodiment, dispersion containing 1-MCP can be prepared as follow: (1) blending 1-MCP complex powder with resin at the temperature slightly over the melting point of the resin; (2) dispersing the blend into oil medium by shearing and obtain a non-aqueous dispersion; (3) consolidating the resin particles by cooling or curing. Thus 1-MCP complex powder can be imbedded in the resin matrix. As the sample is diluted with water, water needs to penetrate into the resin matrix, interacts with the imbedded 1-MCP complex, and releases 1-MCP from the complex. Thus, compared to pure 1-MCP complex powder, slow release of 1-MCP can be achieved upon dilution with water. Such embodiments can enable uniform delivery of 1-MCP to plants, permitting effective and consistent use in field conditions, and offering significant improvement in regulating plant physiology.

As the composition is mixed with water, penetration of water into the resin matrix causes the water to contact and interact with the imbedded active ingredient (for example, 1-MCP complex powder) and releases the active ingredient (for example, 1-MCP) from the complex. Compared to unprotected (or uncoated) 1-MCP complex powder, slow release of 1-MCP can be achieved upon dilution of a composition as described above with water. That also allows uniform delivery of 1-MCP to plants, permitting effective and consistent use in field conditions, and offering significant improvement in regulating plant physiology.

A suitable oil medium may include a mineral oil, an edible oil or a mixture thereof. In one embodiment, the oil medium comprises a mineral oil, which may comprise light mixtures of alkanes in the C15 to C40 range, or a distillate of petroleum. Further examples of oils that can be used include, but are not limited to, mineral oil, light mineral oils, Isopar oil, Unipar oil and other hydrocarbon oils, edible oils and mixture thereof.

Suitable surfactants include, for example, anionic surfactants, nonionic surfactants, and mixtures thereof. Some suitable anionic surfactants include, but not limited to, sulfates, and the sulfonates. Some suitable nonionic surfactants include, but not limited to, ethoxylates of fatty alcohols, ethoxylates of fatty acids, block copolymer of polyoxyethylene and polyolefin, and mixture thereof.

Suitable resins are not limited to a polymer resin with the same chemical structures or same molecule weight, but can also include blends of two or more resins. Suitable resins for use in the methods and compositions disclosed herein include, but are not limited to, polyester, polyether, epoxy resin, isocyanate, organic amine, ethylene vinyl acetate copolymer, natural or synthesized wax, and mixture thereof. In one embodiment, at least one component of the resin has an attraction, preferably a relatively strong interaction with a cyclopropene molecular complex, preferably with HAIP, which can aid in the detention of complex particles within the resin matrix. In one embodiment, the resin has a melting point below 100° C., and a viscosity below 10,000 centipoises.

In one embodiment, the resin comprises a polyester resin. One example of a suitable polyester resin is a polycaprolactone polyol (“PCL”). In various embodiments, the molecular weight of the polycaprolactone polyol is from 1,000 to 200,000; from 2,000 to 50,000; from 2,000 to 8,000; or from 2,000 to 4,000, inclusive of all ranges within these ranges. In various embodiments, the polycaprolactone polyol has a melting point from 30° C. to 120° C.; from 40° C. to 80° C.; or from 50° C. to 60° C., inclusive of all ranges within these ranges. For example, resins including PCL with molecular weight about 120,000 can have a melting point about 60° C. In one embodiment, this kind of resin with a 60° C. melting point is useful for the disclosed methods and compositions. 1-Methylcyclopropene/alpha-cyclodextrin complex (referred to herein as “HAIP”) is known to tolerate temperature about 100° C. for a short duration (for example four minutes) without significant activity loss.

In one embodiment, suitable resins may have melting point of 55° C. or higher; 65° C. or higher; or 70° C. or higher. In another embodiment, suitable resins may have melting point of 100° C. or lower; or 90° C. or lower.

Another method of assessing fatty compounds is the temperature of onset of the melting point. To determine the onset temperature, the exotherm curve (heat flow vs. temperature) produced by the DSC for the melting point transition is observed. The baseline is determined, and a corrected heat-flow curve calculated by subtracting the baseline from the original heat-flow curve. The maximum heat-flow value of the corrected curve (HFMAX) is determined The onset temperature is the lowest temperature at which the heat-flow value on the corrected curve is equal to 0.1*HFMAX. Suitable resins may have onset temperature of 45° C. or higher; or 55° C. or higher.

In various embodiments, the ratio of the consolidated particles (also referred to herein as “resin/complex particles”) to the oil may be from about 1:5 to about 1:25; or from about 1:10 to about 1:24, inclusive of all ranges within these ranges. In embodiments including one or more surfactants, the ratio of the surfactants to the oil may be from about 2:1 to about 1:20; or from about 1:1 to about 1:10, inclusive of all ranges within these ranges. In various embodiments including HAIP powders, the ratio of the HAIP powder to resins may be from about 1:1 to 1:100; or from about 1:2: to about 1:100, inclusive of all ranges within these ranges. In various embodiments, the ratio of the resins to the oil may be from about 2:1 to about 1:100; or from about 1:1 to about 1:100, inclusive of all ranges within these ranges.

As used herein, the term “resin” is synonymous with “polymer” and refers to a relatively large molecule made up of the reaction products of smaller chemical repeat units. The repeat units may be all identical or may include two or more different repeat units. Polymer molecules may have structures including linear, branched, star-shaped, and mixtures thereof. Polymer molecular weights can be measured by standard methods such as, for example, size exclusion chromatography (SEC, also called gel permeation chromatography or GPC). Polymers have number-average molecular weight (Mn) of greater than 700. “Oligomer” as used herein is also a molecule made up of the reaction products of smaller chemical repeat units called monomer units. Oligomers have molecular weight of 700 or less.

A thermoplastic is a polymer that becomes pliable or moldable above a specific temperature, and returns to a solid state upon cooling. In terms of structure characteristics, it can be linear, branched, or star-shaped, where no chemical crosslinking between different molecules. Resins like PCT with M. W. ˜120,000 also melt at 60° C. Such resin can be called thermoplastic.

As used herein, a material is water-insoluble if the amount of that material that can be dissolved in water at 25° C. is 1 gram of material or less per 100 grams of water.

As used herein, when reference is made to a collection of powder particles, the phrase “most or all of the powder particles” means 50% to 100% of the powder particles, by weight based on the total weight of the collection of powder particles.

As used herein, a “solvent compound” is a compound that has boiling point at one atmosphere pressure of between 20° C. and 200° C. and that is liquid at one atmosphere pressure over a range of temperatures that includes 20° C. to 30° C. A “solvent” can be a solvent compound or a mixture of solvents. A non-aqueous solvent can be a solvent that either contains no water or that contains water in an amount of 10% or less by weight based on the weight of the solvent.

As used herein, the phrase “aqueous medium” refers to a composition that is liquid at 25° C. and that contains 75% or more water by weight, based on the weight of the aqueous medium. Ingredients that are dissolved in the aqueous medium are considered to be part of the aqueous medium, but materials that are not dissolved in the aqueous medium are not considered to be part of the aqueous medium. An ingredient is “dissolved” in a liquid if individual molecules of that ingredient are distributed throughout the liquid and are in intimate contact with the molecules of the liquid.

As used herein, when any ratio is said to be X:1 or higher, that ratio is meant to be Y:1, where Y is X or higher. Similarly, when any ratio is said to be R:1 or lower, that ratio is meant to be S:1, where S is R or lower.

As used herein, the “aspect ratio” of a solid particle is the ratio of the particle's longest dimension to that particle's shortest dimension. A particle's longest dimension is the length of the longest possible line segment (“segment L”) that passes through the particle's center of mass and that has each of its end points on the surface of the particle. That particle's shortest dimension is the length of the shortest possible line segment (“segment S”) that passes through the particle's center of mass, that has each of its end points on the surface of the particle, and that is perpendicular to segment L. The aspect ratio is the ratio of the length of segment L to the length of segment S.

As used herein, the “diameter” of a non-spherical particle is the average of the length of that particle's segment L and that particle's segment S. It is noted that, when the particle is spherical, this definition gives the “diameter” in the usual sense.

As used herein, when a property of a powder is described as having a “median” value, it is contemplated that half of the total volume of powder particles will consist of particles that have that property with a value above that median value and that half of the total volume of powder particles will consist of particles that have that property with a value below that median value.

The practice of the present invention involves the use of one or more cyclopropene compound. As used herein, a cyclopropene compound is any compound with the formula

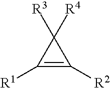

where each R¹, R², R³ and R⁴ is independently selected from the group consisting of H and a chemical group of the formula:

—(L)ₙ—Z

where n is an integer from 0 to 12. Each L is a bivalent radical. Suitable L groups include, for example, radicals containing one or more atoms selected from H, B, C, N, O, P, S, Si, or mixtures thereof. The atoms within an L group may be connected to each other by single bonds, double bonds, triple bonds, or mixtures thereof. Each L group may be linear, branched, cyclic, or a combination thereof. In any one R group (i.e., any one of R¹, R², R³ and R⁴) the total number of heteroatoms (i.e., atoms that are neither H nor C) is from 0 to 6. Independently, in any one R group the total number of non-hydrogen atoms is 50 or less. Each Z is a monovalent radical. Each Z is independently selected from the group consisting of hydrogen, halo, cyano, nitro, nitroso, azido, chlorate, bromate, iodate, isocyanato, isocyanido, isothiocyanato, pentafluorothio, and a chemical group G, wherein G is a 3 to 14 membered ring system.

The R¹, R², R³, and R⁴ groups are independently selected from the suitable groups. Among the groups that are suitable for use as one or more of R¹, R², R³, and R⁴ are, for example, aliphatic groups, aliphatic-oxy groups, alkylphosphonato groups, cycloaliphatic groups, cycloalkylsulfonyl groups, cycloalkylamino groups, heterocyclic groups, aryl groups, heteroaryl groups, halogens, silyl groups, other groups, and mixtures and combinations thereof. Groups that are suitable for use as one or more of R¹, R², R³, and R⁴ may be substituted or unsubstituted.

Among the suitable R¹, R², R³, and R⁴ groups are, for example, aliphatic groups. Some suitable aliphatic groups include, for example, alkyl, alkenyl, and alkynyl groups. Suitable aliphatic groups may be linear, branched, cyclic, or a combination thereof. Independently, suitable aliphatic groups may be substituted or unsubstituted.

As used herein, a chemical group of interest is said to be “substituted” if one or more hydrogen atoms of the chemical group of interest is replaced by a substituent.

Also among the suitable R¹, R², R³, and R⁴ groups are, for example, substituted and unsubstituted heterocyclyl groups that are connected to the cyclopropene compound through an intervening oxy group, amino group, carbonyl group, or sulfonyl group; examples of such R¹, R², R³, and R⁴ groups are heterocyclyloxy, heterocyclylcarbonyl, diheterocyclylamino, and diheterocyclylaminosulfonyl.

Also among the suitable R¹, R², R³, and R⁴ groups are, for example, substituted and unsubstituted heterocyclic groups that are connected to the cyclopropene compound through an intervening oxy group, amino group, carbonyl group, sulfonyl group, thioalkyl group, or aminosulfonyl group; examples of such R¹, R², R³, and R⁴ groups are diheteroarylamino, heteroarylthioalkyl, and diheteroarylaminosulfonyl.

Also among the suitable R¹, R², R³, and R⁴ groups are, for example, hydrogen, fluoro, chloro, bromo, iodo, cyano, nitro, nitroso, azido, chlorato, bromato, iodato, isocyanato, isocyanido, isothiocyanato, pentafluorothio; acetoxy, carboethoxy, cyanato, nitrato, nitrito, perchlorato, allenyl, butylmercapto, diethylphosphonato, dimethylphenylsilyl, isoquinolyl, mercapto, naphthyl, phenoxy, phenyl, piperidino, pyridyl, quinolyl, triethylsilyl, trimethylsilyl; and substituted analogs thereof.

As used herein, the chemical group G is a 3 to 14 membered ring system. Ring systems suitable as chemical group G may be substituted or unsubstituted; they may be aromatic (including, for example, phenyl and napthyl) or aliphatic (including unsaturated aliphatic, partially saturated aliphatic, or saturated aliphatic); and they may be carbocyclic or heterocyclic. Among heterocyclic G groups, some suitable heteroatoms are, for example, nitrogen, sulfur, oxygen, and combinations thereof. Ring systems suitable as chemical group G may be monocyclic, bicyclic, tricyclic, polycyclic, spiro, or fused; among suitable chemical group G ring systems that are bicyclic, tricyclic, or fused, the various rings in a single chemical group G may be all the same type or may be of two or more types (for example, an aromatic ring may be fused with an aliphatic ring).

In one embodiment, one or more of R¹, R², R³, and R⁴ is hydrogen or (C₁-C₁₀) alkyl. In another embodiment, each of R¹, R², R³, and R⁴ is hydrogen or (C₁-C₈) alkyl. In another embodiment, each of R¹, R², R³, and R⁴ is hydrogen or (C₁-C₄) alkyl. In another embodiment, each of R¹, R², R³, and R⁴ is hydrogen or methyl. In another embodiment, R¹ is (C₁-C₄) alkyl and each of R², R³, and R⁴ is hydrogen. In another embodiment, R¹ is methyl and each of R², R³, and R⁴ is hydrogen, and the cyclopropene compound is known herein as 1-methylcyclopropene or “1-MCP.”

In one embodiment, a cyclopropene compound can be used that has boiling point at one atmosphere pressure of 50° C. or lower; 25° C. or lower; or 15° C. or lower. In another embodiment, a cyclopropene compound can be used that has boiling point at one atmosphere pressure of −100° C. or higher; −50° C. or higher; −25° C. or higher; or 0° C. or higher.

The compositions disclosed herein include at least one molecular encapsulating agent. In preferred embodiments, at least one molecular encapsulating agent encapsulates one or more cyclopropene compound or a portion of one or more cyclopropene compound. A complex that includes a cyclopropene compound molecule or a portion of a cyclopropene compound molecule encapsulated in a molecule of a molecular encapsulating agent is known herein as a “cyclopropene compound complex” or “cyclopropene molecular complex.”

In one embodiment, at least one cyclopropene compound complex is present that is an inclusion complex. In a further embodiment for such an inclusion complex, the molecular encapsulating agent forms a cavity, and the cyclopropene compound or a portion of the cyclopropene compound is located within that cavity.

In another embodiment for such inclusion complexes, the interior of the cavity of the molecular encapsulating agent is substantially apolar or hydrophobic or both, and the cyclopropene compound (or the portion of the cyclopropene compound located within that cavity) is also substantially apolar or hydrophobic or both. While the present invention is not limited to any particular theory or mechanism, it is contemplated that, in such apolar cyclopropene compound complexes, van der Waals forces, or hydrophobic interactions, or both, cause the cyclopropene compound molecule or portion thereof to remain within the cavity of the molecular encapsulating agent.

The amount of molecular encapsulating agent can usefully be characterized by the ratio of moles of molecular encapsulating agent to moles of cyclopropene compound. In one embodiment, the ratio of moles of molecular encapsulating agent to moles of cyclopropene compound can be 0.1 or larger; 0.2 or larger; 0.5 or larger; or 0.9 or larger. In another embodiment, the ratio of moles of molecular encapsulating agent to moles of cyclopropene compound can be 10 or lower; 5 or lower; 2 or lower; or 1.5 or lower.

Suitable molecular encapsulating agents include, for example, organic and inorganic molecular encapsulating agents. Suitable organic molecular encapsulating agents include, for example, substituted cyclodextrins, unsubstituted cyclodextrins, and crown ethers. Suitable inorganic molecular encapsulating agents include, for example, zeolites. Mixtures of suitable molecular encapsulating agents are also suitable. In one embodiment, the molecular encapsulating agent comprises alpha-cyclodextrin, beta-cyclodextrin, gamma-cyclodextrin, or combinations thereof. In a further embodiment, the molecular encapsulating agent comprises alpha-cyclodextrin.

In one embodiment, complex powders may have median particle diameter of 100 micrometers or less; 75 micrometers or less; 50 micrometers or less; or 25 micrometers or less. In another embodiment, complex powders may have median particle diameter of 10 micrometers or less; 7 micrometers or less; or 5 micrometers or less. In another embodiment, complex powders may have median particle diameter of 0.1 micrometer or more; or 0.3 micrometer or more. Median particle diameter may be measured by light diffraction using a commercial instrument such as those manufactured, for example, by Horiba Co. or Malvern Instruments.

In another embodiment, complex powders may have median aspect ratio of 5:1 or lower; 3:1 or lower; or 2:1 or lower. If a complex powder is obtained that has undesirably high median aspect ratio, mechanical means may be used, for example, milling, to reduce the median aspect ratio to a desirable value.

In the practice of the present invention, one or more oils are used. As used herein, the phrase “oil” refers to a compound that is liquid at 25° C. and 1 atmosphere pressure and that has a boiling point at 1 atmosphere pressure of 30° C. or higher. As used herein, “oil” does not include water, does not include surfactants, and does not include dispersants.

In some embodiments, one or more oil may be used that has boiling point of 50° C. or higher; or 75° C. or higher; or 100° C. or higher. In some embodiments, every oil that is used has boiling point of 50° C. or higher. In some embodiments, every oil that is used has boiling point of 75° C. or higher. In some embodiments, every oil that is used has boiling point of 100° C. or higher. Independently, in some of the embodiments that use oil, one or more oil may be used that has an average molecular weight of 100 or higher; or 200 or higher; or 500 or higher. In some embodiments, every oil that is used has average molecular weight of 100 or higher. In some embodiments, every oil that is used has average molecular weight of 200 or higher. In some embodiments, every oil that is used has average molecular weight of 500 or higher.

An oil may be either a hydrocarbon oil (i.e., an oil whose molecule contains only atoms of carbon and hydrogen) or a non-hydrocarbon oil (i.e., an oil whose molecule contains at least at least one atom that is neither carbon nor hydrogen).

Some suitable hydrocarbon oils are, for example, straight, branched, or cyclic alkane compounds with 6 or more carbon atoms. Some other suitable hydrocarbon oils, for example, have one or more carbon-carbon double bond, one or more carbon-carbon triple bond, or one or more aromatic ring, possibly in combination with each other and/or in combination with one or more alkane group. Some suitable hydrocarbon oils are obtained from petroleum distillation and contain a mixture of compounds, along with, in some cases, impurities. Hydrocarbon oils obtained from petroleum distillation may contain a relatively wide mixture of compositions or may contain relatively pure compositions. In some embodiments, hydrocarbon oils are used that contain 6 or more carbon atoms. In some embodiments, hydrocarbon oils are used that contain 18 or fewer carbon atoms. In some embodiments, every hydrocarbon oil that is used contains 18 or fewer carbon atoms. In some embodiments, every hydrocarbon oil that is used contains 6 or more carbon atoms. Some suitable hydrocarbon oils include, for example, hexane, decane, dodecane, hexadecane, diesel oil, refined paraffinic oil (e.g., Ultrafine™ spray oil from Sun Company), and mixtures thereof. In some embodiments, every oil that is used is a hydrocarbon oil.

Among embodiments that use non-hydrocarbon oil, some suitable non-hydrocarbon oils are, for example, fatty non-hydrocarbon oils. “Fatty” means herein any compound that contains one or more residues of fatty acids. Fatty acids are long-chain carboxylic acids, with chain length of at least 4 carbon atoms. Typical fatty acids have chain length of 4 to 18 carbon atoms, though some have longer chains. Linear, branched, or cyclic aliphatic groups may be attached to the long chain. Fatty acid residues may be saturated or unsaturated, and they may contain functional groups, including for example alkyl groups, epoxide groups, halogens, sulfonate groups, or hydroxyl groups, that are either naturally occurring or that have been added. Some suitable fatty non-hydrocarbon oils are, for example, fatty acids; esters of fatty acids; amides of fatty acids; dimers, trimers, oligomers, or polymers thereof; and mixtures thereof.

Some of the suitable fatty non-hydrocarbon oils, are, for example, esters of fatty acids. Such esters include, for example, glycerides of fatty acids. Glycerides are esters of fatty acids with glycerol, and they may be mono-, di-, or triglycerides. A variety of triglycerides are found in nature. Most of the naturally occurring triglycerides contain residues of fatty acids of several different lengths and/or compositions. Some suitable triglycerides are found in animal sources such as, for example, dairy products, animal fats, or fish. Further examples of suitable triglycerides are oils found in plants, such as, for example, coconut, palm, cottonseed, olive, tall, peanut, safflower, sunflower, corn, soybean, linseed, tung, castor, canola, citrus seed, cocoa, oat, palm, palm kernel, rice bran, cuphea, or rapeseed oil.

Among the suitable triglycerides, independent of where they are found, are those, for example, that contain at least one fatty acid residue that has 14 or more carbon atoms. Some suitable triglycerides have fatty acid residues that contain 50% or more by weight, based on the weight of the residues, fatty acid residues with 14 or more carbon atoms, or 16 or more carbon atoms, or 18 or more carbon atoms. One example of a suitable triglyceride is soybean oil.

Suitable fatty non-hydrocarbon oils may be synthetic or natural or modifications of natural oils or a combination or mixture thereof. Among suitable modifications of natural oils are, for example, alkylation, hydrogenation, hydroxylation, alkyl hydroxylation, alcoholysis, hydrolysis, epoxidation, halogenation, sulfonation, oxidation, polymerization, and combinations thereof. In some embodiments, alkylated (including, for example, methylated and ethylated) oils are used. One suitable modified natural oil is methylated soybean oil.

Also among the suitable fatty non-hydrocarbon oils are self-emulsifying esters of fatty acids.

Another group of suitable non-hydrocarbon oils is the group of silicone oils. Silicone oil is an oligomer or polymer that has a backbone that is partially or fully made up of —Si—O— links. Silicone oils include, for example, polydimethylsiloxane oils. Polydimethylsiloxane oils are oligomers or polymers that contain units of the form

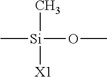

where at least one of the units has X1=CH₃. In other units, X1 may be any other group capable of attaching to Si, including, for example, hydrogen, hydroxyl, alkyl, alkoxy, hydroxyalkyl, hydroxyalkoxy, alkylpolyalkoxyl, substituted versions thereof, or combinations thereof. Substituents may include, for example, hydroxyl, alkoxyl, polyethoxyl, ether linkages, ester linkages, amide linkages, other substituents, or any combination thereof. In some embodiments, every oil that is used is a silicone oil.

In some suitable polydimethylsiloxane oils, all X1 groups are groups that are not hydrophilic. In some suitable polydimethylsiloxane oils, all X1 groups are alkyl groups. In some suitable polydimethylsiloxane oils, all X1 groups are methyl. In some embodiments, every silicone oil is a polydimethylsiloxane oil in which all X1 groups are methyl. In some suitable polydimethylsiloxanes, at least one unit has an X1 group that is not methyl; if more than one non-methyl X1 unit is present, the non-methyl X1 units may be the same as each other, or two or more different non-methyl X1 units may be present. Polydimethylsiloxane oils may be end-capped with any of a wide variety of chemical groups, including, for example, hydrogen, methyl, other alkyl, or any combination thereof. Also contemplated are cyclic polydimethylsiloxane oils.

Mixtures of suitable oils are also suitable.

In another aspect of the present disclosure, there is provided a method for making a composition comprising resin/complex particles suspended in oil (hereafter, “carrier composition”). In one embodiment, a method for preparing a composition comprises: (a) blending an active ingredient with a resin at a temperature higher than the melting point of the resin to provide a blend; (b) dispersing the blend into an oil medium at a temperature higher than the melting point of the resin to provide a dispersion comprising dispersed particles in the oil medium; and (c) consolidating the dispersed particles to provide consolidated particles comprising a solid matrix of the resin impregnated with the active ingredient. In one embodiment, the process temperature is slightly higher than the melting point of the resin and the process time is less than twenty minutes. In another embodiment, the process temperature is slightly higher than the melting point of the resin and below 100° C., and the process time is less than twenty minutes. In one embodiment, the method includes, before said dispersing, mixing surfactant into the oil at a temperature higher than the melting point of the surfactant. In another embodiment, said mixing includes applying shear forces to the mixture.

In one embodiment, the blending of any of the above-described embodiments includes applying shear forces to the blend. In another embodiment, the dispersing of any of the above-described embodiments includes applying shear forces to the dispersion. Consolidating particles in accordance with the present disclosure can be achieved for example, by cooling small quantities of the resin/complex dispersion to a temperature below the melting point of the resin (i.e., in the case of thermoplastic resins). The temperature lower than the melting point of the resin can be, for example, ambient temperature.

In another embodiment, a method for preparing a composition comprises: (a) blending an active ingredient (for example, 1-MCP complex powder) with a resin at the temperature slightly over the melting point of the resin; (b) dispersing the blend into an oil medium including a surfactant by shearing and obtain an oil dispersion; (c) consolidating the resin particles by cooling (i.e., in the case of a thermoplastic resin). Thus, the active ingredient (for example, 1-MCP complex powder) is dispersed or imbedded in the resin matrix particles, which particles are suspended in the oil medium.

A carrier composition of the present disclosure may be used for treating plants or plant parts in any way. For example, a carrier composition may be mixed with other materials or may be used directly.

In another aspect, the present disclosure provides a method of using a carrier composition as described herein for a formation of an aqueous slurry. An aqueous slurry can be formed when the composition provided is mixed with an aqueous medium. To form such a slurry, the aqueous medium may be mixed directly with the carrier composition. It is expected that the resin/complex particles of the carrier composition remain intact in the slurry. It is also contemplated that most or all of the resin/complex particles will be dispersed in the slurry as individual particles rather than as agglomerates thereof. The resin/complex particles may require mechanical agitation to remain suspended in the aqueous medium, or they may remain suspended without agitation.

The amount of carrier composition provided in the slurry may be characterized by the concentration of cyclopropene compound in the slurry. In one embodiment, suitable slurries may have cyclopropene compound concentration, in units of milligrams of cyclopropene compound per liter of slurry, of 2 or higher; 5 or higher; or 10 or higher. In another embodiment, suitable slurries may have cyclopropene compound concentration, in units of milligrams of cyclopropene compound per liter of slurry, of 1000 or lower; 500 or lower; or 200 or lower.

The amount of water in the aqueous medium used in the slurry may be, by weight based on the weight of aqueous medium, 80% or more; 90% or more; or 95% or more.

The slurry may optionally include one or more adjuvants, for example and without limitation, one or more metal complexing agent, alcohol, extender, pigment, filler, binder, plasticizer, lubricant, wetting agent, spreading agent, dispersing agent, sticker, adhesive, defoamer, thickener, transport agent, emulsifying agent or mixtures thereof. Some of such adjuvants commonly used in the art can be found in the John W. McCutcheon, Inc. publication Detergents and Emulsifiers, Annual, Allured Publishing Company, Ridgewood, N. J., U.S.A. Examples of metal-complexing agents, if used, include chelating agents. Examples of alcohols, if used, include alkyl alcohols with 4 or fewer carbon atoms.

Also provided is a method of treating plants by bringing the slurry into contact with plants or plant parts. Such contacting may be performed in any location, including inside enclosed spaces (for example, containers, rooms, or buildings) or outside of an enclosed space. In one embodiment, such contacting is performed outside of any enclosed space. As used herein, “outside of any enclosed space” means outside of any building or enclosure or else in a room or building that is ventilated to outdoor atmosphere. In another embodiment, such contacting is performed outside of any building or enclosure. In a further embodiment, such contacting is performed in an outdoor field or plot.

The slurry of the present disclosure may be brought into contact with plants or plant parts by methods known in the art. Examples of methods include dipping plant parts into the slurry and applying slurry to plants or plant parts by spraying, foaming, brushing, or combinations thereof. Other examples include spraying the slurry onto plants or plant parts and dipping plant parts into the slurry. Additional examples include spraying the slurry onto plants or plant parts.

Plants or plant parts may be treated in the practice of the present invention. One example is treatment of whole plants; another example is treatment of whole plants while they are planted in soil, prior to the harvesting of useful plant parts.

Any plants that provide useful plant parts may be treated in the practice of the present invention. Examples include plants that provide fruits, vegetables, and grains.

As used herein, the phrase “plant” includes dicotyledons plants and monocotyledons plants and fruit. Examples of dicotyledons plants include tobacco, Arabidopsis, soybean, tomato, papaya, canola, sunflower, cotton, alfalfa, potato, grapevine, pigeon pea, pea, Brassica, chickpea, sugar beet, rapeseed, watermelon, melon, pepper, peanut, pumpkin, radish, spinach, squash, broccoli, cabbage, carrot, cauliflower, celery, Chinese cabbage, cucumber, eggplant, and lettuce. Examples of monocotyledons plants include corn, rice, wheat, sugarcane, barley, rye, sorghum, orchids, bamboo, banana, cattails, lilies, oat, onion, millet, and triticale. Examples of fruit include papaya, banana, pineapple, oranges, grapes, grapefruit, watermelon, melon, apples, peaches, pears, kiwifruit, mango, nectarines, guava, persimmon, avocado, lemon, fig, and berries.

As used herein, the phase “plant growth regulator” includes, but not limited to, ethylene, cyclopropenes, glyphosate, glufosinate, and 2,4-D. Other suitable plant growth regulators have been disclosed in International Patent Application Publication WO 2008/071714A1, which is incorporated by reference in its entirety.

Additional suitable plant growth regulators include famoxadone; or carboxylic amides selected from benalaxyl, benodanil, boscalid, carboxin, mepronil, fenfuram, fenhexamid, flutolanil, furametpyr, metalaxyl, ofurace, oxadixyl, oxycarboxin, penthiopyrad, thifluzamid, tiadinil, 4-difluoromethyl-2-methyl-thiazol-5-carboxylic acid-(4′-bromo-biphenyl-2-yl)-amide, 4-difluoromethyl-2-methyl-thiazol-5-carboxylic acid-(4′-trifluoromethyl-biphenyl-2-yl)-amide, 4-difluoromethyl-2-methyl-thiazol-5-carboxylic acid-(4′-chloro-3′-fluoro-biphenyl-2-yl)-amide, 3-difluoromethyl-1-methyl-pyrazol-4-carboxylic acid-(3′,4′-dichloro-4-fluoro-biphenyl-2-yl)-amide, 3,4-dichloro-isothiazol-5-carboxylic acid-(2-cyano-phenyl)-amide, dimethomorph, flumorph, flumetover, fluopicolide (picobenzamid), zoxamide, carpropamide, diclocymet, mandipropamid, N-(2-(4-[3-(4-chloro-phenyl)-prop-2-inyloxy]-3-methoxy-phenyl)-ethyl)-2-methanesulfo-nylamino-3-methyl-butyramid and N-(2-(4-[3-(4-chloro-phenyl)-prop-2-inyloxy]-3-methoxy-phenyl)-ethyl)-2-ethanesulfonylamino-3-methyl-butyramide.

Additional suitable plant growth regulators include azoles selected from bitertanole, bromuconazole, cyproconazole, difenoconazole, diniconazole, enilconazole, epoxiconazole, fenbuconazole, flusila-zole, fluquinconazole, flutriafol, hexaconazole, imibenconazole, ipconazole, metconazole, myclobutanil, penconazole, propiconazole, prothioconazole, simeconazole, tebuconazole, tetraconazole, triadimenol, triadimefon, triticona-zole, cyazofamid, imazalil, pefurazoate, prochloraz, triflumizol, benomyl, carbendazim, fuberidazole, thiabendazole, ethaboxam, etridiazole and hymexa-zole; and nitrogen-containing heterocyclic compounds selected from fluazinam, pyrifenox, 3-[5-(4-chloro-phenyl)-2,3-dimethyl-isoxazolidin-3-yl]-pyridine, bupirimat, cyprodinil, ferimzon, fenarimol, mepanipyrim, nuarimol, pyrimethanil, tri-forin, fludioxonil, fenpiclonil, aldimorph, dodemorph, fenpropimorph, tridemorph, iprodion, procymidon, vinclozolin, acibenzolar-5-methyl, anilazin, captan, captafol, dazomet, diclomezine, fenoxanil, folpet, fenpropidin, famoxadone, fenamidone, octhilinon, probenazol, proquinazid, pyroquilon, quinoxyfen, tricyclazol, 2-butoxy-6-iodo-3-propyl-chromen-4-one, 3-(3-bromo-6-fluoro-2-methyl-indole-1-sulfonyl)-[1,2,4]triazole-1-sulfonic acid dimethylamide.

Additional suitable plant growth regulators include carbamates and dithiocarbamates selected from ferbam, mancozeb, metiram, metam, propineb, thiram, zineb, ziram, diethofencarb, flubenthiavalicarb, iprovalicarb, propamocarb, 3-(4-chloro-phenyl)-3-(2-isopropoxy carbonylamino-3-methyl-butyrylamino)-propionic acid methylester and N-(1-(1-(4-cyanophenyl)ethanesulfonyl)-but-2-yl) carbamic acid-(4-fluorophenyl)ester; guanidines selected from dodin, iminoctadine and guazatin; and antibiotics selected from kasugamycin, polyoxine, streptomycin and valida-mycin A.

Additional suitable plant growth regulators include fentin salts; sulfur-containing heterocyclic compounds selected from isoprothiolan and dithianon; organophosphorous compounds selected from edifenphos, fosetyl, fosetyl-aluminium, iprobenfos, pyrazophos, tolclofos-methyl, phosphoric acid and the salts thereof; organo-chloro compounds selected from thiophanate methyl, chlorothalonil, dichlofluanid, tolylfluanid, flusulfamid, phthalide, hexachlorbenzene, pency-curon, quintozen; nitrophenyl derivatives selected from binapacryl, dinocap and dinobuton; and inorganic active ingredients selected from Bordeaux composition, copper acetate, copper hydroxide, copper oxychloride, basic copper sulfate and sulfur.

Additional suitable plant growth regulators include spiroxamine; cyflufenamide; cymoxanil; metrafenone; organo(thio)phosphates selected from acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos and trichlorfon; carbamates selected from alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicar and triazamate; and pyrethroids selected from allethrin, bifenthrin, cyfluthrin, cyhalothrin, cy-phenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin and profluthrin, dimefluthrin.

Additional suitable plant growth regulators include (a) chitin synthesis inhibitors that are selected from the benzoylureas chlorfluazuron, diflubenzuron, flucycloxuron, flufenoxuron, hexaflumuron, lufenuron, novaluron, teflubenzuron, triflumuron; buprofezin, diofenolan, hexythiazox, etoxazole and clofentazine; (b) ecdysone antagonists that are selceted from halofenozide, methoxyfenozide, tebufenozide and azadirachtin; (c) juvenoids that are selected from pyriproxyfen, methoprene and fenoxycarb; and (d) lipid biosynthesis inhibitors that are selected from spi-rodiclofen, spiromesifen and spirotetramat.

Additional suitable plant growth regulators include nicotinic receptor agonists/antagonists compoundsselected from clothianidin, dinotefuran, imidacloprid, thiamethoxam, nitenpyram, acetamiprid, thiacloprid; and the thiazol compound of formula (I):

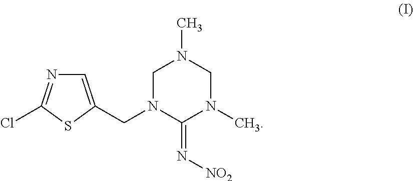 [SMILES: CN1CN(C)/C(=N\[N+](=O)[O-])N(Cc2cnc(Cl)s2)C1]

Additional suitable plant growth regulators include chlorfenapyr; cyromazine; indoxacarb; piperonyl butoxide; METI I compounds selected from fenazaquin, pyridaben, tebufenpyrad, tolfenpyrad and flufenerim; METI II and III compounds selected from acequinocyl, fluacyprim and hydramethylnon; oxidative phosphorylation inhibitor compounds selected from cyhexatin, diafenthiuron, fenbutatin oxide and propargite; and GABA antagonist compoundsselected from acetoprole, endosulfan, ethi-prole, fipronil, vaniliprole, pyrafluprole, pyriprole and the phenylpyrazole compound of formula (II):

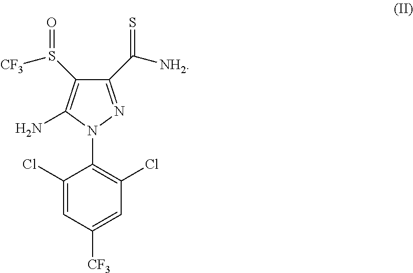 [SMILES: NC(=S)c1nn(-c2c(Cl)cc(C(F)(F)F)cc2Cl)c(N)c1S(=O)C(F)(F)F]

Additional suitable plant growth regulators include benclothiaz, bifenazate, cartap, flonicamid, pyridalyl, pymetrozine, sulfur, thiocyclam, flubendiamide, cyenopyrafen, flupyra-zofos, cyflumetofen, amidoflumet, the aminoquinazolinone compound of formula r (III):

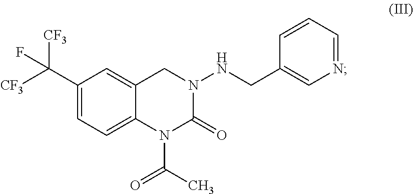 [SMILES: CC(=O)N1C(=O)N(NCc2cccnc2)Cc2cc(C(F)(C(F)(F)F)C(F)(F)F)ccc21]

and anthranilamide compounds of formula r (IV):

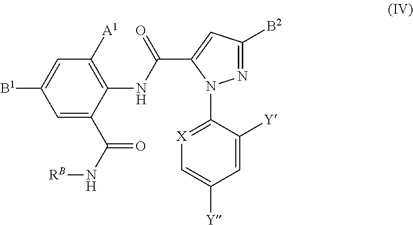

wherein A¹ is CH₃, Cl, Br, or I; X is C—H, C—Cl, C—F or N; Y′ is F, Cl, or Br; Y″ is F, Cl, or CF₃; B¹ is hydrogen, Cl, Br, I, or CN; B² is Cl, Br, CF₃, OCH₂CF₃, or OCF₂H, and R^{B} is hydrogen, CH₃ or CH(CH₃)₂.

Additional suitable plant growth regulators include lipid biosynthesis inhibitors selected from chlorazifop, clodinafop, clofop, cyhalofop, diclofop, fenoxaprop, fenoxaprop-p, fenthiaprop, fluazifop, fluazifop-P, haloxyfop, haloxyfop-P, isoxapyrifop, metamifop, propaquizafop, quizalofop, quizalofop-P, trifop, alloxydim, butroxydim, clethodim, cloproxydim, cycloxydim, profoxydim, sethoxydim, tepraloxydim, tralkoxydim, butylate, cycloate, diallate, dimepiperate, EPTC, esprocarb, ethiolate, isopolinate, methiobencarb, molinate, orbencarb, pebulate, prosulfocarb, sulfallate, thiobencarb, tiocarbazil, triallate, vernolate, benfuresate, ethofumesate, bensulide and pinoxaden; ALS inhibitors selected from amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, imazamethabenz, imazamox imazapic, imazapyr, imazaquin, imazethapyr, cloransulam, diclosulam, florasulam, flumetsulam, metosulam, penoxsulam, bispyribac, pyriminobac, propoxycarbazone, flucarbazone, pyribenzoxim, pyriftalid, pyrithiobac, flucetosulfuron, orthosulfamuron, pyrimisulfan; and photosynthesis inhibitors selected from atraton, atrazine, ametryne, aziprotryne, cyanazine, cyanatryn, chlorazine, cyprazine, desmetryne, dimethametryne, dipropetryn, eglinazine, ipazine, mesoprazine, methometon, methoprotryne, procyazine, proglinazine, prometon, prometryne, propazine, sebuthylazine, secbumeton, simazine, simeton, simetryne, terbumeton, terbuthy-lazine, terbutryne, trietazine, ametridione, amibuzin, hexazinone, isomethiozin, metamitron, metribuzin, bromacil, isocil, lenacil, terbacil, brompyrazon, chlorida-zon, dimidazon, desmedipham, phenisopham, phenmedipham, phenmedipham-ethyl, benzthiazuron, buthiuron, ethidimuron, isouron, methabenzthiazuron, monoisouron, tebuthiuron, thiazafluoron, anisuron, buturon, chlorbromuron, chlo-returon, chlorotoluron, chloroxuron, difenoxuron, dimefuron, diuron, fenuron, fluometuron, fluothiuron, isoproturon, linuron, methiuron, metobenzuron, meto-bromuron, metoxuron, monolinuron, monuron, neburon, parafluoron, phenobenzuron, siduron, tetrafluoron, thidiazuron, cyperquat, diethamquat, difenzo-quat, diquat, morfamquat, paraquat, bromobonil, bromoxynil, chloroxynil, iodobonil, ioxynil, amicarbazone, bromofenoxim, flumezin, methazole, bentazone, propanil, pentanochlor, pyridate, and pyridafol.

Additional suitable plant growth regulators include protoporphyrinogen-IX oxidase inhibitors selected from acifluorfen, bifenox, chlomethoxyfen, chlornitrofen, ethoxyfen, fluorodifen, fluoroglycofen, fluoronitrofen, fomesafen, furyloxyfen, halosafen, lactofen, nitrofen, nitrofluorfen, oxyfluorfen, fluazolate, pyraflufen, cinidon-ethyl, flumiclorac, flumioxazin, flumipropyn, fluthiacet, thidiazimin, oxadiazon, oxadiargyl, azafenidin, carfentrazone, sulfentrazone, pentoxazone, benzfendizone, butafenacil, pyraclonil, profluazol, flufenpyr, flupropacil, nipyraclofen, etnipromid, and bencarbazone; bleacher herbicides selected from metflurazon, norflurazon, flufenican, diflufenican, picolinafen, beflubutamid, fluridone, fluorochloridone, flurtamone, mesotrione, sulcotrione, isoxachlortole, isoxaflutole, benzofenap, pyrazolynate, pyrazoxyfen, benzobicyclon, amitrole, clomazone, aclonifen, 4-(3-trifluoromethyl-phenoxy)-2-(4-trifluoromethylphenyl)pyrimidine, topramezone, 4-hydroxy-3-{[2-methyl-6-(trifluoromethyl)-3-pyridinyl]carbonyl}bicyclo[3.2.1]oct-3-en-2-one, 4-hydroxy-3-{[2-(2-methoxyethoxy)methyl-6-(trifluoro-methyl)-3-pyridinyl]carbonyl}bicylo[3.2.1]oct-3-en-2-one, 4-hydroxy-3-[4-(methylsulfonyl)-2-nitrobenzoyl]bicyclo[3.2.1]-oct-3-en-2-one, 2-[2-chloro-4-(methylsulfonyl)-3-[(2,2,2-trifluoroethoxy)methyl]benzoyl]-3-hydroxy-2-cyclohexen-1-one and pyrasulfotole.

Additional suitable plant growth regulators include glyphosate in its acid form or as a derivative thereof, such as the mono isopropylammonium salt, the sodium salt, trimesium salt (sulfosate) or a mixture thereof; glutamine synthase inhibitors selected from glufosinate and bilanaphos; asulam; mitose inhibitors selected from benfluralin, butralin, dinitramine, ethalflu-ralin, fluchloralin, isopropalin, methalpropalin, nitralin, oryzalin, pendimethalin, prodiamine, profluralin, trifluralin, amiprofos-methyl, butamifos, dithiopyr, thia-zopyr, propyzamide, tebutam, chlorthal, carbetamide, chlorbufam, chlorpropham and propham; VLCFA inhibitors selected from acetochlor, alachlor, butachlor, bu-tenachlor, delachlor, diethatyl, dimethachlor, dimethenamid, dimethenamid-P, metazachlor, metolachlor, S-metolachlor, pretilachlor, propachlor, propisochlor, prynachlor, terbuchlor, thenylchlor, xylachlor, allidochlor, CDEA, epronaz, diphenamid, napropamide, naproanilide, pethoxamid, flufenacet, mefenacet, fentrazamide, anilofos, piperophos, cafenstrole, indanofan and tridiphane; cellulose biosynthesis inhibitors selected from dichlobenil, chlorthiamid, isoxaben and flupoxam; decoupler herbicides selected from dinofenate, dinoprop, dinosam, di-noseb, dinoterb, DNOC, etinofen and medinoterb.

Additional suitable plant growth regulators include auxin herbicides selected from clomeprop, 2,4-D, 2,4,5-T, MCPA, MCPA thioethyl, dichlorprop, dichlorprop-P, mecoprop, mecoprop-P, 2,4-DB, MCPB, chloramben, dicamba, 2,3,6-TBA, tricamba, clopyralid, fluoroxypyr, picloram, tri-clopyr, benazolin, aminopyralid, quinclorac, and quinmerac; auxin transport inhibitors selected from naptalam and diflufenzopyr; benzoylprop, flamprop, flamprop-M, bromobutide, chlorflurenol, cinmethylin, methyldymron, etobenzanid, fosamine, metam, pyributicarb, oxazi-clomefone, dazomet, triaziflam, methyl bromide, and endothal; inhibitors of ethylene biosynthesis which block the conversion of ACC into ethylene selected from Co²⁺or Ni²⁺ions; radical-scavenging phenolic substances including n-propyl gallate; polyamines including putrescine, spermine, spermidine; structural ACC analogs including alpha-aminoisobutyric acid, L-aminocyclopropene-1-carboxylic acid; salicylic acid including its synthetic analogon acibenzolar-S-methyl; structural analogs of ascorbic acid which act as inhibitors of ACC oxidase including prohexadione-Ca or trinexapac-ethyl; triazolyl compounds as inhibitors of cytochrome P-450-dependent monooxygenase; inhibitors of the action of ethylene 2,5-norbornadiene, and 3-amino-1,2,4-triazole or Ag²⁺ions; and ethylene biosynthesis inhibitors which inhibit the conversion of S-adenosyl-L-methionine into 1-aminocyclopropane-1-carboxylic acid (ACC) including derivatives of vinylglycine, hydroxylamines, or oxime ether.

### EXAMPLES

### Example 1

### Sample Preparation

Steps to make cyclopropene molecular complex powder in oil suspension—The samples are prepared as follows:

(a) Air milled HAIP (1-methylcyclopropene/alpha-cyclodextrin complex) powder and polymer resin is charged into a vessel, then the vessel is placed in a oil bath and heated to temperature slightly over melting point of the resin. The HAIP powder is evenly dispersed into the resin under shearing, thus a viscous dispersion is obtained.
(b) A surfactant is added into oil, followed by heating the mixture to above the highest melting point of the surfactant under shearing to get a uniform mixture, typically a clear solution. Then the solution is cooled to a temperature slightly over the melting point of resin.
(c) The HAIP powder dispersion in resin from step (a) is added into the mixture of oil and surfactant from step (b). The HAIP powder dispersion in resin from step (a) is dispersed into the mixture of oil and surfactant from step (b) by high speed shearing at a temperature slightly above melting point of the resin.
(d) The dispersed particles are consolidated by cooling.

### Example 2

### Test Methods

The release of 1-MCP from samples upon mixture of the samples with water (referred to herein as “release of diluted samples”) is investigated as follow: About 0.35 g sample and 0.1 g of surfactants are charged into a vial of 22 ml and the mixture is blended evenly by shearing. Then 2 ml water is added to the vial and milk like emulsion is obtained after shearing. A series of diluted samples are prepared using this method. After placing the vials at ambient temperature for a certain period of time, the sample can be analyzed by gas chromatography to observe concentration variation of 1-MCP and to track and detect the effective release of 1-MCP. The head space analysis measurement is taken after a given time period after the sample is diluted with water. Each vial is sampled once, that is, a new vial is used to obtain each data point for time release studies.

From the measure concentration of 1-MCP in the headspace, the amount of sample added to the vial and the theoretical 1-MCP content in the sample, the fraction of the total amount of 1-MCP in the vial that resides in the headspace, can be calculated and reported as a percentage based on the amount of 1-MCP added to the vial.

The release of 1-MCP from the samples is compared to the release of 1-MCP from HAIP powder. For measuring the release of 1-MCP from HAIP, about 20 mg of HAIP powder is weighed into a 22 ml headspace vial and 2 ml water is injected. The head space analysis measurement is taken under the same conditions described above.

### Example 3

### Preparation of Sample #1

Sample #1 is prepared as the following:

(1) 22.88 g polyester resin is added to a vessel, and the vessel is heated to the melting point of the polyester, i.e., 60° C. After all the resin melts, 5.72 g HAIP powder is charged into the vessel, and the mixture is thoroughly mixed by shearing for about ten minutes, after which the HAIP powder is evenly dispersed in the melt resin to provide a viscous HAIP dispersion.

(2) 60.43 g mineral oil and 6.74 g paraffin wax are charged into a vessel, and the vessel is heated to the melting point of the wax, i.e., 60° C. After all the wax melts 0.81 g Unithox 720, 1.88 g Unithox 750 and 1.34 g SDBS are added, and the mixture is heated to about 110° C. The mixture is then thoroughly mixed by shearing, followed by cooling to 60° C. to provide a surfactant dispersion.

(3) HAIP dispersion (1) is blended with surfactant dispersion (2) under high shearing for about three minutes at about 60° C.; the resin is dispersed into mineral oil to form particles wherein HAIP imbedded. Then the dispersion is cooled down to ambient temperature.

### Example 4

### Preparation of Sample #2

Sample #2 is prepared as the following:

(1) 22.88 g polyester resin is added to a vessel, and the vessel is heated to the melting point of the polyester, i.e., 60° C. After all the resin melts, 5.72 g HAIP powder is charged into the vessel, and the mixture is thoroughly mixed by shearing for about ten minutes, after which the HAIP powder is evenly dispersed in the melt resin to provide a viscous HAIP dispersion.

(2) 67.37 g mineral oil, 0.81 g Unithox 720, 1.88 g Unithox 750 and 1.34 g SDBS are charged into a vessel, and then the mixture is heated to about 110° C. The mixture is then thoroughly mixed by shearing, followed by cooling to 60° C. to provide a surfactant dispersion.

(3) HAIP dispersion (1) is blended with surfactant dispersion (2) under high shearing for about three minutes at about 60° C.; the resin is dispersed into mineral oil to form particles wherein HAIP imbedded. Then the dispersion is cooled down to ambient temperature.

Formulations of Sample #1 and Sample #2 are summarized in Table 1, below.

| | | | Comparative |
|---|---|---|---|
| Ingredients | Sample #1 | Sample #2 | sample 1 |
| HAIP powder* | 5.72 g | 5.72 g | Only this powder |
| Polyester resin | 22.88 g | 22.88 g | |
| Mineral oil | 60.63 g | 67.37 g | |
| Surfactant Unithox 720 | 0.81 g | 0.81 g | |
| Surfactant Unithox 750 | 1.88 g | 1.88 g | |
| Sodium dodecyl benzene | 1.34 g | 1.34 g | |
| sulfonate (SDBS) | | | |
| Paraffin Wax | 6.74 g | 0 g | |
| Total weight | 100.00 g | 100.00 g | |

*HAIP is 1-MCP complex powder containing about 4.5% 1-methylcyclopropene.

### Example 5

### Comparative Samples

Comparative samples are prepared as the following:

(1) HAIP+water system: 20 mg HAIP powder is sealed in a vial, and 2 ml water is injected, 1-MCP concentration in head space is analyzed by gas chromatography. FIG. 2 shows the release profile of 1-MCP from HAIP powder upon contact with water. As shown in FIG. 2, at ambient temperature, 1-MCP is released and diffused completely in about ten minutes from HAIP upon contact with water.

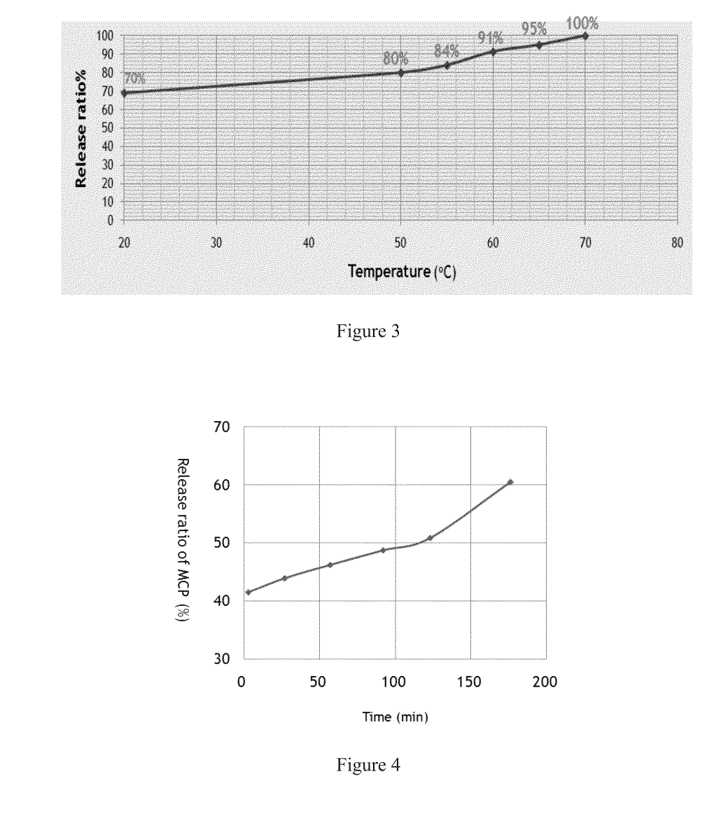

(2) HAIP+oil+water system: 20 mg HAIP powder is first blended with 250 mg oil under shearing, then the mixture and surfactant are sealed in a vial, and water is injected, then the vial is shaken to obtain a uniform emulsion. After that, the diluted samples are held at different temperatures (22, 50, 55, 60, 65 and 70° C.) for 30 minutes. 1-MCP concentration in head space is analyzed by gas chromatography at corresponding temperatures. FIG. 3 shows the release profile of 1-MCP. As shown in FIG. 3, after emulsified samples are held at 22, 50, 55, 60, 65 and 70° C. for 30 minutes, released 1-MCP into head space at each temperature are 70%, 80%, 84%, 91%, 95% and 100%, respectively. That is, the release ratios increase with the increase of temperature, and under current conditions only 70% 1-MCP released into head space at ambient temperature, and even if the sample are held at this temperature for longer time the release ratio is still ˜70%.

### Example 6

### Release Profiles of Test Samples

FIG. 4 shows a representative release profile of 1-MCP from the diluted Sample #1. As shown in FIG. 4, the head space concentration of 1-MCP increased over time. After contact with water for about ten minutes, 1-MCP was still released from the emulsion, and it was released continually even after contact with water for about 180 minutes.

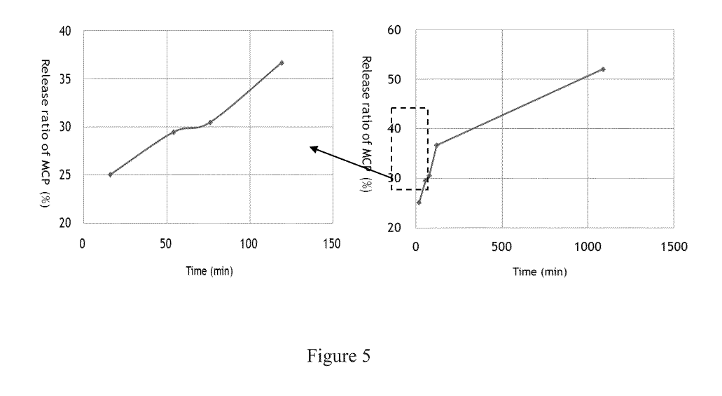

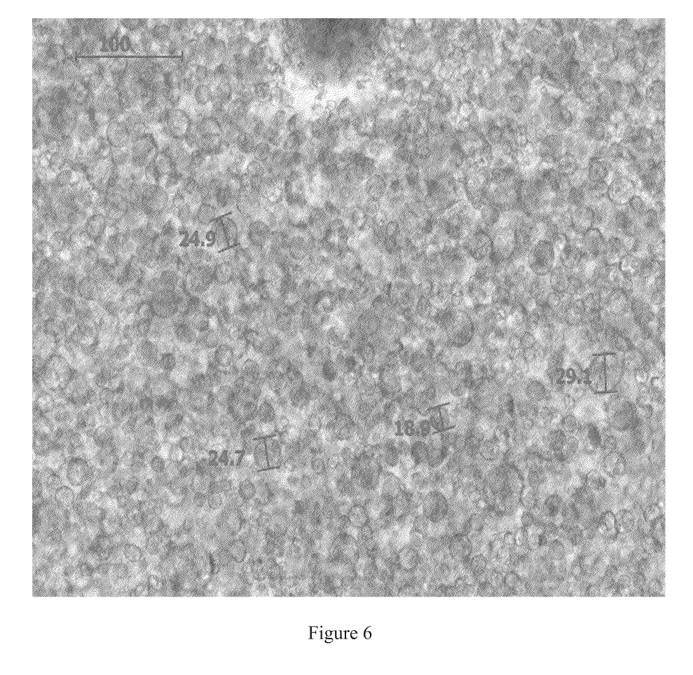

FIG. 5 shows a representative release profile of 1-MCP from the diluted Sample #2. As shown in FIG. 5, the head space concentration of 1-MCP increased over time. 1-MCP was released continually even after contact with water for longer than 1000 minutes.

In view of the above, the matrix encapsulated composition of the present disclosure is convenient for use in liquid form. Compared to HAIP powder form, slow release of 1-MCP can be achieved upon diluting and emulsifying the dispersion with water, and give longer application time. This also allows uniform delivery of 1-MCP upon water dilution, permitting effective and consistent use in field conditions. Compared to oil droplets encapsulation formulation in which 1-MCP content is very low (less than 50 ppm) since 1-MCP gas is used, 1-MCP content can increase to more than 200,000 ppm since complex powder can be used to conduct the encapsulation in this disclosure. The selected materials including oil medium and resin matrix only lose less than 3% of 1-MCP at process temperature.

### Example 7

### Optical Images of Test Samples

FIG. 6 depicts a typical optical image of the dispersions described herein. As shown in FIG. 6, the particle size is about 10-30 microns.

1.-26. (canceled)

27. A method for preparing a composition, comprising,
(a) blending an active ingredient with a resin at a temperature higher than the melting point of the resin to provide a blend;
(b) dispersing the blend into an oil medium at a temperature higher than the melting point of the resin to provide a dispersion comprising dispersed particles in the oil medium; and
(c) consolidating the dispersed particles to provide consolidated particles comprising a solid resin matrix in which the active ingredient is embedded.

28. The method of claim 27, further comprising, before said dispersing, mixing a surfactant into the oil at a temperature higher than the melting point of the surfactant to provide a mixture.

29. The method of claim 28, wherein the ratio of the surfactant to the oil is from about 2:1 to about 1:20, by weight.

30. The method of claim 28, wherein the ratio of the surfactant to the oil is from about 1:1 to about 1:10, by weight.

31. The method of claim 28, wherein said mixing includes applying shear forces to said mixture.

32. The method of claim 27, wherein said blending includes applying shear forces to said blend.

33. The method of claim 27, wherein said dispersing includes applying shear forces to said dispersion.

34. The method of claim 27, wherein said consolidating comprises cooling the dispersion to a temperature lower than the melting point of the resin.

35. The method of claim 27, wherein said consolidating does not comprise curing.

36. The method of claim 27, wherein the oil medium comprises a mixture of alkanes of C15 to C40, or a distillate of petroleum.

37. The method of claim 27, wherein the oil medium comprises a member selected from the group consisting of a mineral oil, an edible oil, and combinations thereof.

38. The method of claim 27, wherein the temperature lower than the melting point of the resin is ambient temperature.

39. The method of claim 27, wherein the ratio of the resin to the oil is from about 2:1 to about 1:100, by weight.

40. The method of claim 27, wherein the ratio of the resin to the oil is from about 1:1 to about 1:100, by weight.

41. The method of claim 27, wherein the active ingredient comprises a volatile compound.

42. The method of claim 41, wherein the volatile compound comprises a cyclopropene.

43. The method of claim 42, wherein the cyclopropene is of the formula: 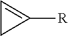
wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

44. The method of claim 43, wherein R is C₁₋₈ alkyl.

45. The method of claim 43, wherein R is methyl.

46. The method of claim 42, wherein the cyclopropene is of the formula: 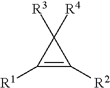
wherein R¹ is a substituted or unsubstituted C₁-C₄ alkyl, C₁-C₁ alkenyl, C₁-C₄ alkynyl, C₁-C₄ cylcoalkyl, cylcoalkylalkyl, phenyl, or napthyl group; and R², R³, and R⁴ are hydrogen.

47. The method of claim 45, wherein the cyclopropene comprises 1-methylcyclopropene (1-MCP).

48. The method of claim 27, wherein the active ingredient comprises a complex comprising a cyclopropene and a molecular encapsulating agent.

49. The method of claim 48, wherein the molecular encapsulating agent comprises alpha-cyclodextrin, beta-cyclodextrin, gamma-cyclodextrin, or combinations thereof.

50. The method of claim 49, wherein the molecular encapsulating agent comprises alpha-cyclodextrin.

51. The method of claim 27, wherein the active ingredient comprises a plant growth regulator.

52. The method of claim 27, wherein the resin comprises a polyester resin.

53. The method of claim 27, wherein the resin comprises a resin selected from the group consisting of a polyester, a polyether, an epoxy resin, an isocyanate, an organic amine, an ethylene vinyl acetate copolymer, a natural or synthesized wax, and combinations thereof.

54. The method of claim 27, wherein the resin comprises a polycaprolactone polyol.

55. The method of claim 27, wherein the resin comprises a polycaprolactone polyol having a molecular weight from about 2,000 to about 4,000.

56. The Method of claim 27, wherein the resin comprises a polycaprolactone polyol having a melting point from about 50° C. to about 60° C.

57.-63. (canceled)
